(19) United States
(12) Patent Application Publication
(10) Pub. No.: US 2005/0197884 A1
(43) Pub. Date: Sep. 8, 2005

(54) System and method for designing and conducting surveys and providing anonymous results

(76) Inventor: James G. Mullen JR., Drexel Hill, PA (US)

Correspondence Address: DESIGN IP, 5000 W. TILGHMAN STREET, SUITE 153, ALLENTOWN, PA, 18104, US

(21) Appl. No.: 10/794,326

(22) Filed: Mar. 4, 2004

(51) Int. Cl. G06F 17/60

(52) U.S. Cl. 705/10

(57) ABSTRACT

A computer-implemented system and method for conducting surveys. A survey design interface via a network enables a requester to create a survey to be completed by each of a plurality of participants identified by the requester. A survey response interface allows each participant is to input a response to the survey. Anonymous survey data relating to each participant's response is gathered and a report is provided to the requestor regarding the anonymous survey data.

### FIELD OF INVENTION

This invention relates to a system and method of designing and conducting surveys and providing anonymous results.

### SUMMARY OF THE INVENTION

In one respect, the invention comprises a computer-implemented method for conducting surveys. The method includes a survey design interface via a network that enables a requester to create a survey to be completed by each of a plurality of participants identified by the requester. A survey response interface is provided, through which each participant is allowed to input a response to the survey. Survey data relating to each participant's response is gathered and a report is provided to the requestor regarding the survey data in an anonymous format.

In another respect, the invention comprises a computer-based application for conducting anonymous surveys. The application includes a survey design interface, a survey response interface and an analysis module. The survey design interface enables a requester to create a survey to be completed by each of a plurality of participants identified by the requester. The survey response interface enables each participant to input responses to the survey. The analysis module gathers survey data relating to each participant's response and provides a report to the requestor in which the survey data is provided in an anonymous format.

### BRIEF DESCRIPTION OF THE DRAWING(S)

The following detailed description of the preferred embodiments of the invention will be better understood when read in conjunction with the appended drawings. For the purposes of illustrating the invention, there is shown in the drawings embodiments which are presently preferred. It is understood, however, the invention is not limited to the precise arrangements and instrumentalities shown in the drawings:

FIG. 1 is a block diagram of the present invention.

FIG. 2 is a flow chart showing the handling of a survey once it has been designed and finalized by a requestor.

### DETAILED DESCRIPTION OF THE PREFERRED EMBODIMENT(S)

The principles of the present invention are better understood with reference to the drawings and the accompanying description.

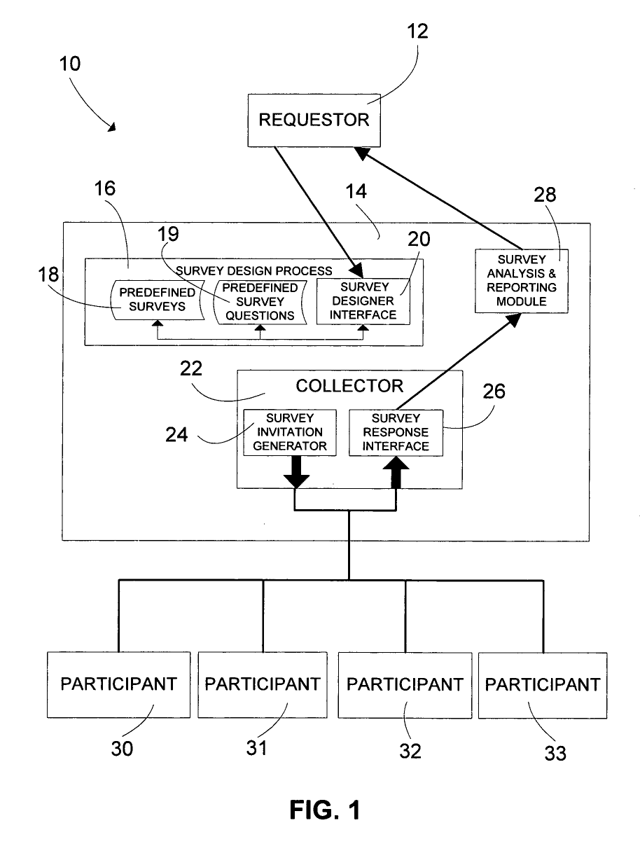

Referring to FIG. 1, the present invention comprises a system 10 for designing and conducting surveys and providing anonymous results. There are three general steps involved in using the system 10: (1) designing and requesting a survey, (2) inviting the participants to complete the survey and (3) analyzing and reporting the survey results.

Designing & Requesting a Survey

The system 10 provides a computer-implemented survey designer interface 20 for the person 12 requesting that the survey be conducted (hereinafter “requester”). The interface 20 preferably provides the option for the requestor 12 to use a complete pre-defined survey 18 (pre-defined survey), a survey in which the requestor picks individual pre-defined survey questions 19 (semi-custom survey), or a survey created entirely by the requestor (custom survey).

The pre-defined surveys 18 and individual pre-defined survey questions 19 are provided for the benefit of requestors that are not experienced in designing effective surveys. The custom survey option is provided to give requestors with survey experience, such as customer service managers, human resource professionals, and employee placement professionals, for example, more control over the contend and layout of the survey. This process of designing the survey through the interface 20 is referred to herein as the survey design process 16.

Once the survey is completed and approved by the requestor, the interface 20 asks the requestor 12 to provide pertinent information regarding each person that the requestor would like to answer to survey (hereinafter “participants”). Such information should include at least a first name and email address, but may also include additional information. Optionally, the requestor 12 may be given the option to categorize participants. Categorizing participants would allow analysis of the survey results to be broken down by category. As part of the survey design process, the requestor 12 is asked not to discuss the survey with others (particularly the survey participants) until the survey results have been reported, in order to prevent affecting the survey results.

The survey designer interface 20 could be implemented through a software application located on a personal computer with internet access or a web-based interface that is accessible to the requester 12 using a web browser. In either case, it is preferable that data containing the complete predefined surveys 18 and individual predefined survey questions 19 be stored in a remote, secure and centralized location. This will allow the predefined survey questions to be updated easily and prevent unauthorized use.

Inviting Participants to Complete the Survey

Once the requestor 12 has completed the survey design process 16, the survey is forwarded to a collector interface 22. The collector interface 22 includes a survey invitation generator 24 that forwards a survey invitation to each participant 30-33 and a survey response interface 26 that allows each participant to view and complete the survey.

The survey invitation directs the participant to a URL where the survey can be completed. In order to improve the quality of the survey results, the invitation preferably indicates that the survey is to be taken seriously, that the requestor has paid a fee for the survey, and requests that the participant not discuss the survey with others at least until a notification has been received that the survey results have been reported. The invitation also preferably indicates that survey results will be reported in an “anonymous format”. As used herein, the term “anonymous format” means that the survey data will be provided to the requestor in a format that does not associate a survey response with the participant who provided that response.

It should be noted that, in order to categorize survey results and keep track of which participants have complete survey responses, it will be necessary for the system 10 to maintain identifying data that associates each survey response with the participant who provided it. However, such identifying data will not be provide to or accessible to the requestor 12.

The survey invitation generator 24 preferably generates an email addressed to each participant that includes the survey invitation. Individual emails are preferred so that participants do not know the identities of other participants. Email is the preferred means of forwarding the survey invitation because it is fast and can be directed to an individual. Other means, such as instant messages, a voicemail message, etc., could be used.

The survey response interface 26 is preferably accessible via a web browser, which will simplify submission of completed surveys and provide more control over privacy and security for the survey itself and the survey results. Alternatively, the survey could be forwarded to each participant as a downloadable application or file.

Analyzing and Reporting the Survey Results

The system 10 preferably includes a survey analysis and reporting module 28, which is responsible for receiving survey results that have been entered through the survey response interface 26, tabulating and analyzing the results, and notifying the requestor 12 of the survey results.

Survey results are preferably provided after the either: (1) a predetermined survey response period has passed, or (2) all of the participants have completed the survey. Preferably, survey results are provided only if a minimum number or percentage of surveys have been completed. Optionally, survey results could be withheld if the clear majority of survey results (e.g., more than 80%) are negative. Of course any predetermined criteria could be used as a condition of providing survey results.

A survey results preferably include a report that tabulates the answers to each of the survey questions. The report could provide other statistics and/or other types of information as desired by the administrator of the system 10 or by the requestor 12.

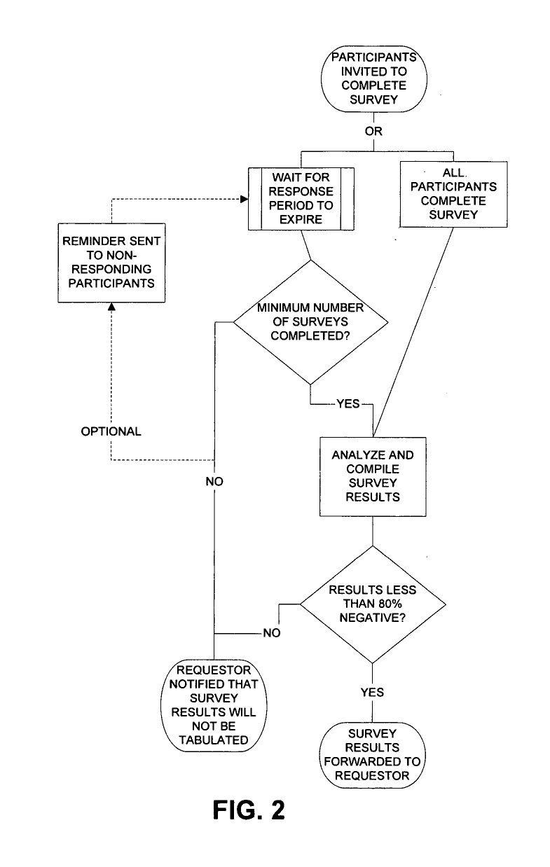

FIG. 2 is a flow chart showing the functional steps involved in collecting survey results and reporting the results to the requestor 12. Once invitation is sent to each participant, the survey analysis and reporting module 28 waits until the response period has expired or until all surveys have been completed, whichever comes first.

If the response period expires before all surveys are completed, the module 28 determines if a minimum number of surveys have been completed. If not, the module 28 will notify the requestor 12 that survey results will not be tabulated or provided. Optionally, the module 28 could direct the survey invitation generator 24 to send a reminder to non-responsive participants and provide a supplemental response period. In addition, a notification could be sent to the requester 12, indicating that the minimum number of participants have not yet responded and that non-responding participants have been given the supplemental response period. The requester 12 could also be invited to submit additional participants. The minimum number of surveys required to provide survey results could be set by the administrator of the system 10 or by the requestor 12.

If a minimum number of surveys are completed, the module 28 tabulates the results. Optionally, the module 28 may confirm whether less than a pre-determined percentage of the results (e.g., 80%) are negative. If so, the module 28 will notify the requestor 12 that survey results will not be tabulated or provided. If not, the module 28 will complete the analysis of the results and provide a report to the requester.

It is recognized by those skilled in the art, that changes may be made to the above-described embodiment of the invention without departing from the broad inventive concept thereof. In particular, all dimensions shown and/or described are intended to be merely exemplary and subject to change without departing from the invention. It is understood, therefore, that this invention is not limited to the particular embodiments disclosed but is intended to cover all modifications which are in the spirit and scope of the invention.

1. A computer-implemented method for conducting surveys comprising:
providing a survey design interface that enables a requester to create a survey to be completed by each of a plurality of participants identified by the requester;
inviting each participant to respond to the survey;
providing a survey response interface, through which each participant is allowed to input responses to the survey;
gathering survey data relating to each participant's response; and
providing a report to the requestor that presents that survey data in an anonymous format.

2. The method of claim 1, wherein providing a survey design interface comprises providing access to complete predefined surveys.

3. The method of claim 1, wherein providing a survey design interface comprises providing access to individual predefined survey questions.

4. The method of claim 1, wherein providing a survey design interface comprises providing an interface in which the requester can create survey questions.

5. The method of claim 1, further comprising requiring the requestor to provide predetermined information regarding each participant.

6. The method of claim 5, wherein requiring the requestor to provide predetermined information regarding each participant, comprises requiring the requestor to provide a name and email address for each participant.

7. The method of claim 6, wherein requiring the requestor to provide predetermined information regarding each participant, comprises requiring the requestor to provide at least one category and associate each participant with one of the at least one category.

8. The method of claim 1, wherein providing a survey design interface comprises providing a web-based survey design interface via a network.

9. The method of claim 1, wherein inviting each participant to respond to the survey using a survey response interface further comprises sending an email message to each participant.

10. The method of claim 1, wherein inviting each participant to respond to the survey using a survey response interface further comprises sending an email message to each participant that directs the participant to a URL that provides access to the survey response interface.

11. The method of claim 11, wherein inviting each participant to respond to the survey using a survey response interface further comprises sending an email message to each participant that requests that each participant does not discuss the survey with anyone.

12. The method of claim 1, wherein inviting each participant to respond to the survey using a survey response interface comprises inviting each participant to respond to the survey using a web-based survey response interface.

13. The method of claim 1, wherein providing a report to the requestor regarding the anonymous survey data comprises providing a message that no survey results will be provided if any predetermined criteria are not met.

14. The method of claim 13, wherein providing a message that no survey results will be provided if any predetermined criteria comprises providing a message that no survey results will be provided if less than a minimum number of participants responds to the survey within a response period.

15. The method of claim 13, wherein providing a message that no survey results will be provided if any predetermined criteria comprises providing a message that no survey results will be provided if more than a predetermined percentage of participant's responses are negative.

16. A computer-based application for conducting anonymous surveys comprising:
a survey design interface that enables a requester to create a survey to be completed by each of a plurality of participants identified by the requester;
a survey response interface that enables each participant to input responses to the survey; and
an analysis module that gathers anonymous survey data relating to each participant's response and provides a report to the requester in which the survey data is provided in an anonymous format.

17. The computer-based application of claim 16, wherein the survey design interface and the survey response interface are accessible via a web browser.

18. The computer-based application of claim 16, wherein the analysis module provides the report only if all predetermined criteria are met.

19. The computer-based application of claim 18, wherein the predetermined criteria include that a minimum number of participants have responded to the survey.

20. The computer-based application of claim 18, wherein the predetermined criteria include that less than a predetermined percentage of responses are negative.

21. The computer-based application of claim 16, further comprising a database including predefined survey questions that can be accessed by the requester through the survey design interface.

22. The computer-based application of claim 16, further comprising a database including predefined complete surveys that can be accessed by the requester through the survey design interface.
